(19) United States
(12) Patent Application Publication
(10) Pub. No.: US 2022/0134598 A1
(43) Pub. Date: May 5, 2022

(54) SYSTEM AND METHODS FOR DEMOLDING CONCRETE BLOCKS AND REINSERTING MOLD INSERTS

(71) Applicant: Rosetta Hardscapes, LLC, Charlevoix, MI (US)

(72) Inventors: Jacob Paul Kloss, Harbor Springs, MI (US); Gabrielle Grace Heinz, Hemlock, MI (US)

(21) Appl. No.: 17/512,493

(22) Filed: Oct. 27, 2021

Related U.S. Application Data
(60) Provisional application No. 63/108,802, filed on Nov. 2, 2020.

(51) Int. Cl. B28B 7/06; B28B 7/08

(52) U.S. Cl. CPC B28B 7/065; B28B 7/08

(57) ABSTRACT

A forming system and methods that can more efficiently, safely, and economically produce pre-cast modular blocks having desired shapes and surfaces, such as those having reverse tapered shapes. The forming system and methods disclosed herein allow for quick, easy, and efficient demolding and reinstalling of inserts for the production of reverse tapered pre-cast modular blocks.

### CROSS REFERENCE TO RELATED APPLICATIONS

The present application claims the benefit to U.S. Provisional Patent Application No. 63/108,802 filed on Nov. 2, 2020, which is incorporated herein by reference in its entirety.

### FIELD

The present disclosure generally relates to a system and methods for demolding concrete blocks and reinserting mold inserts.

### BACKGROUND

For pre-cast modular blocks, specific shaped surfaces, such as a reverse tapered shape have been desired for optimal aesthetics and construction of curves on retaining walls. However, block shape for existing retaining blocks is constrained by currently available manufacturing methods for making blocks with non-reverse tapered shapes.

Existing techniques for manufacturing pre-cast modular blocks with reverse tapered shapes are costly, inefficient, and involve lots of manual labor. As the concrete industry shifts toward lower viscosity concrete, traditional steel forms have difficulty maintaining a “liquid” sealing environment. Thus, additional concrete is present, which requires additional labor and presents inefficiencies for cleaning and cycling traditional forming systems for reverse tapered precast modular blocks. It is very difficult to remove reverse tapered blocks from existing forms due to the significant amount of labor and time involved in the production process associated with existing forms and systems.

Consequently, there is a need for an improved form and method to efficiently (i.e. reduce the cost and manual labor) produce reverse tapered precast modular blocks.

### SUMMARY

What is provided is a forming system and methods that can more efficiently, safely, and economically produce scalable pre-cast modular blocks having desired shapes and surfaces, such as those having reverse tapered shapes. The forming system and methods disclosed herein allow for quick, easy, and efficient demolding and reinstalling of inserts for the production of reverse tapered pre-cast modular blocks. For example, the blocks generated using the forming system and methods disclosed herein no longer require an operator to manually demold or re-insert inserts, to clean the inside of the form, or to align inserts in the form.

In an embodiment, the forming system includes a form assembly configured to cast a concrete block. The form assembly includes a plurality of sides defining one or more openings; a mold liner selectively inserted within the one or more openings, wherein the mold liner includes a plurality of sides and one or more cavities; a rigid support member surrounding the mold liner; and one or more insert assemblies configured to selectively insert into the one or more cavities in the mold liner. The forming system also includes a reaction frame, wherein the reaction frame comprises one or more extending arms configured to selectively engage with the one or more inserts.

In an embodiment, the mold liner has one or more tapered sides.

In an embodiment, the rigid support member includes one or more slots adapted for receiving forklift tines to allow for lifting, moving, and inverting of the rigid support member.

In an embodiment, the mold liner has one or more straps, wherein the one or more straps are configured to moveably connect the mold liner to the rigid support member.

In an embodiment, the insert assemblies include one or more first portions that are each selectively inserted within the cavities of the mold liner; and a second portion attached to the first portion, wherein the second portion includes a hole adapted for receiving at least one of the extending arms of the reaction frame.

In an embodiment, a method for demolding one or more cast concrete blocks from a form assembly includes providing a form assembly having a mold liner inserted within one or more openings in the form assembly, wherein the mold liner includes one or more cavities; a rigid support member surrounding the mold liner; one or more concrete blocks in the cavities of the mold liner; and one or more inserts positioned within the mold liner. The method further includes aligning the form assembly with respect to a reaction frame; engaging one or more portions of the reaction frame with portions of one or more of the inserts; removing the one or more inserts from the mold liner by pulling the form assembly away from the reaction frame; moving the rigid support member with the mold liner and one or more concrete blocks therein away from the reaction frame; rotating the rigid support member with the mold liner and one or more concrete blocks; and releasing the one or more concrete blocks from the mold liner.

In an embodiment, a method for inserting one or more inserts into a form assembly includes providing a reaction frame having one or more extending arms, wherein one or more inserts are engaged to the one or more extending arms; translating a mold liner into a rigid support member on a form assembly, wherein the mold liner includes one or more cavities; aligning the form assembly with the reaction frame such that the one or more inserts are positioned over the cavities in the mold liner; inserting one or more of the inserts into the cavities; and removing the form assembly from the reaction frame such that the inserts are no longer engaged with the reaction frame.

In an embodiment, a form assembly configured to cast a concrete block includes a plurality of sides defining one or more openings; a mold liner selectively inserted within the one or more openings, wherein the mold liner includes one or more tapered sides and one or more cavities; a rigid support member surrounding the mold liner; and one or more inserts positioned in the one or more cavities of the mold liner.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 illustrates a schematic perspective view of a forming system in a first configuration according to an embodiment of the disclosure, the forming system includes a frame assembly and a form assembly;

FIG. 2 illustrates another schematic perspective view of the forming system illustrated in FIG. 1;

FIG. 3 illustrates a front side elevation view of the forming system illustrated in FIGS. 1 and 2;

FIG. 4 illustrates a schematic perspective view of the forming system illustrated in FIGS. 1-3, wherein the forming system is in a second configuration;

FIG. 5 illustrates another schematic perspective view of the forming system illustrated in FIG. 4;

FIG. 6 illustrates a front side elevation view of the forming system illustrated in FIGS. 4 and 5;

FIG. 7 illustrates a schematic top plan view of the form assembly illustrated in FIGS. 4-6;

FIG. 8 illustrates a schematic side perspective view of the forming system illustrated in FIGS. 1-6;

FIG. 9 illustrates a schematic perspective view of the form assembly illustrated in FIGS. 1-8, wherein the form assembly includes a hook holder;

FIG. 10 illustrates a schematic exploded view of the form assembly illustrated in FIG. 9;

FIG. 11 illustrates a schematic perspective view of the frame illustrated in FIGS. 1-6 and 8;

FIG. 12 illustrates a schematic sectional view of a portion of the form assembly illustrated in FIGS. 1-11, wherein the form assembly includes an exemplary block;

FIG. 13 illustrates a schematic perspective view of the form assembly illustrated in FIGS. 1-10 including a block, wherein the form assembly is inverted by a forklift;

FIG. 14 illustrates a schematic side elevational view of the block illustrated in FIGS. 12 and 13;

FIG. 15 illustrates a flow chart of an exemplary method for demolding one or more cast concrete blocks from the form assembly illustrated in FIGS. 1-10, 12, and 13; and

FIG. 16 illustrates a flow chart of an exemplary method for inserting one or more inserts into a mold assembly on the form assembly illustrated in FIGS. 1-10, 12, and 13.

### DETAILED DESCRIPTION

It is to be understood that the present disclosure may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

Directional terms, such as “top,” “bottom,” “inwards,” “upwards,” “downwards,” “perpendicular,” “parallel,” and “laterally” are used in following detailed description for the purpose of providing relative reference only, and are not intended to suggest any limitations on how any article is to be positioned during use, or to be mounted in an assembly or relative to an environment.

Forming systems and methods for demolding concrete blocks and reinserting mold inserts are disclosed herein. The concrete blocks may be pre-cast modular blocks, such as a concrete retaining wall block. The concrete blocks formed herein may simulate other types of texture and may be formed with any desired surface patterns, designs, or configurations.

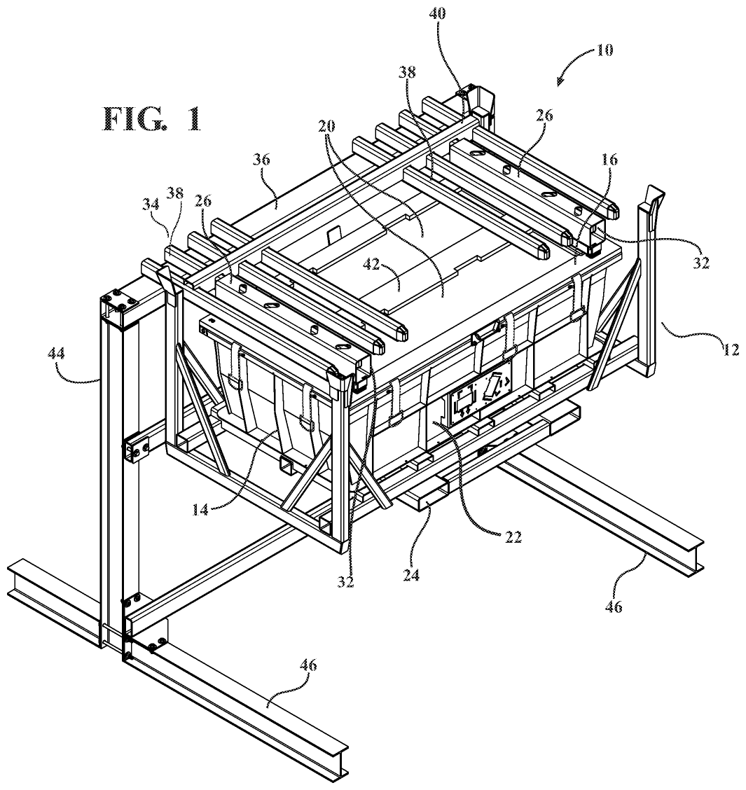

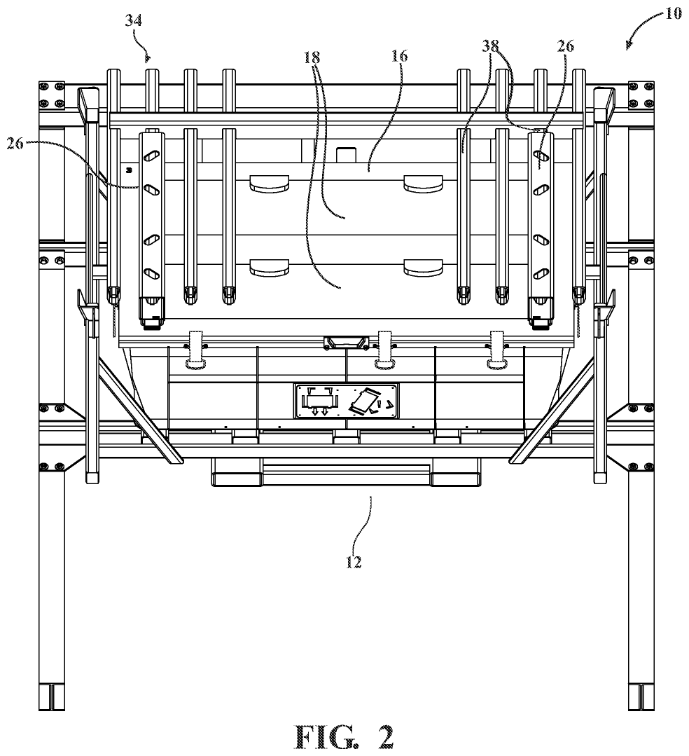

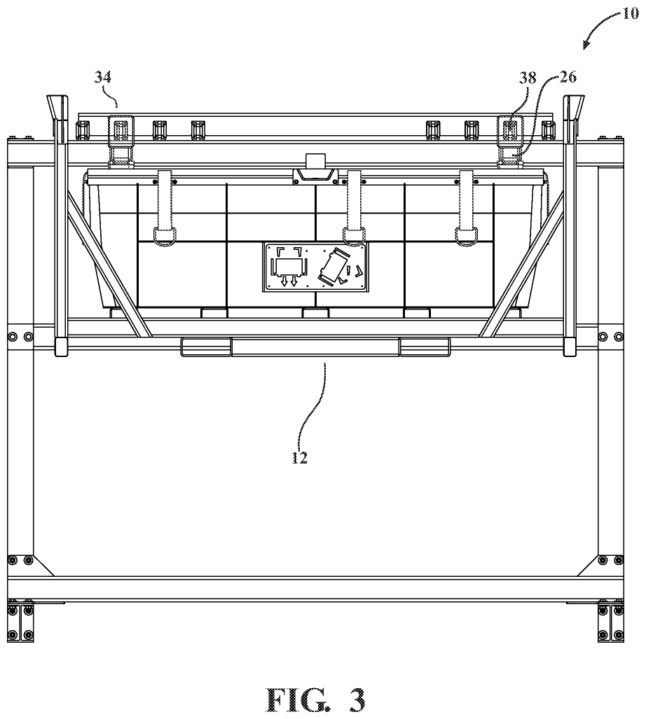

FIGS. 1-3 illustrate views of a forming system 10 in a first configuration according to an embodiment of the disclosure. The forming system 10 comprises a form assembly 12 having a plurality of sides 14. The form assembly 12 is selectively connected to a frame 34, such as a demolding frame, a reaction frame, or an insert re-installation frame. The form assembly 12 may be made from a variety of materials, including steel.

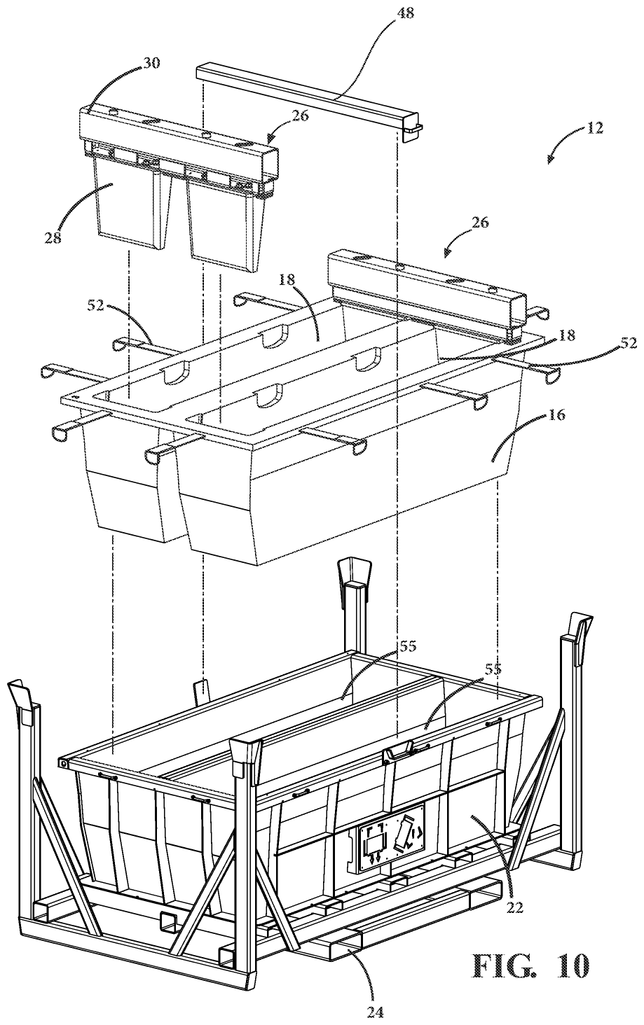

As best seen in FIG. 10 and as a non-limiting example, the form assembly 12 comprises openings 55 for receiving a mold assembly 16 therein. The mold assembly 16 may comprise a mold liner. One or more portions of the mold assembly 16 are mated to one or more portions of the form assembly 12 when the mold assembly 16 is inserted therein. The mold assembly 16 may be constructed from a resilient material, such as polyurethane. The mold assembly 16 may comprise a variety of sizes and shapes. For example, the mold assembly 16 may comprise one or more tapered surfaces to improve the alignment and insertion of the mold assembly 16 into the inner space of the form assembly 12.

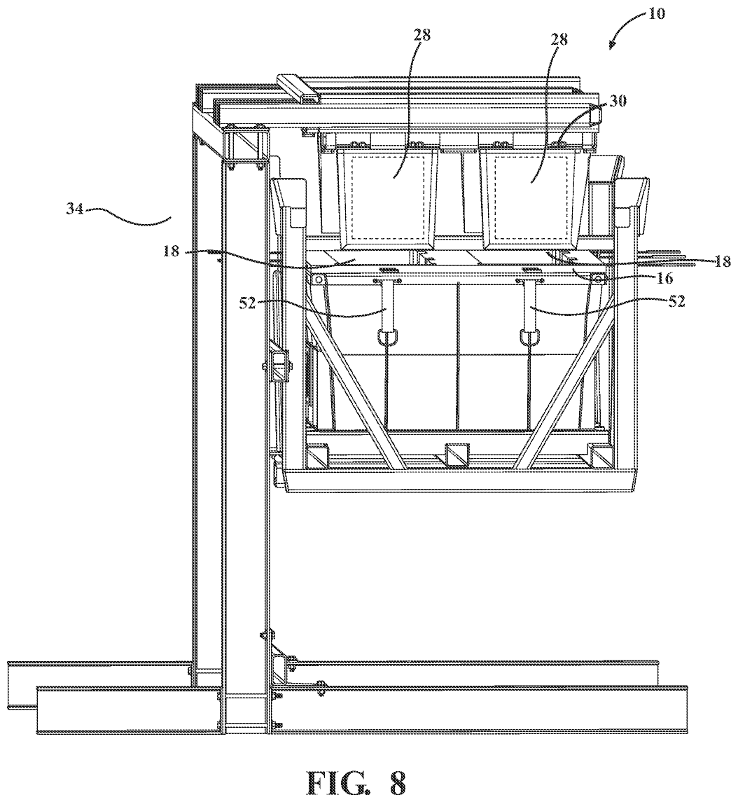

As best seen in FIGS. 1, 8, and 10 and as a non-limiting example, the form assembly 12 comprises one or more straps 52 for moveably connecting the mold assembly 16 to one or more portions of the form assembly 12, such as the tub 22. The straps 52 provide specified displacement limits between the mold assembly 16 and the tub 22. In an example, the straps 52 comprise tethers having a first end embedded in the mold assembly 16 and a second, opposing end secured to one or more portions of the form assembly 12, such as the tub 22. In this embodiment, the form assembly 12 comprises ten tethers/straps 52. One of ordinary skill in the art would understand that other form assemblies may include either less than or more than ten tethers/straps depending on the size of the respective form assembly.

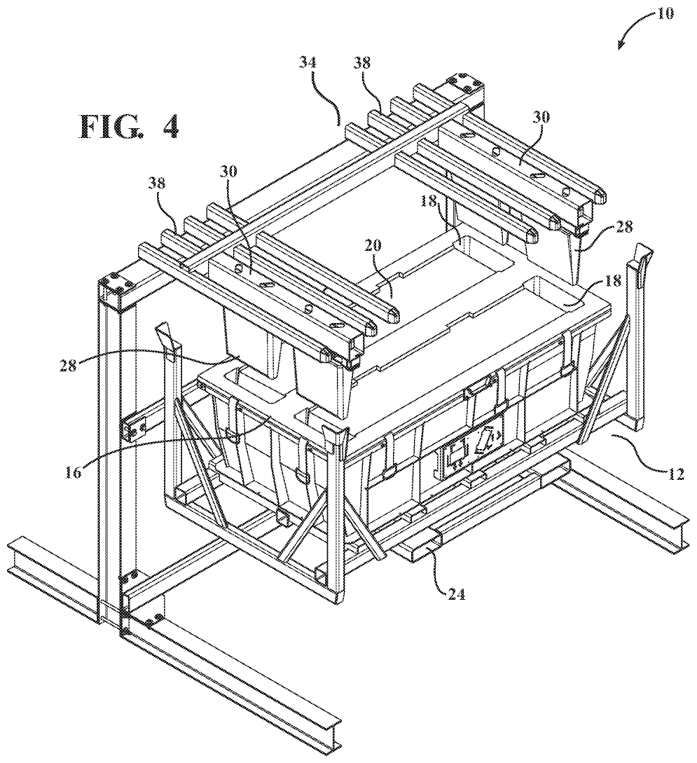

As best seen in FIGS. 1 and 4, and as a non-limiting example, the exemplary mold assembly 16 includes a middle portion 42 defining two cavities 18 adapted for simultaneously casting two concrete blocks 20. It will be appreciated that in other embodiments where there is only cavity, the mold assembly 16 may not include the middle portion 42. As a result, the mold assembly 16 may be designed for casting only a single concrete block or simultaneously casting a desired number of concrete blocks. The concrete blocks 20 may be cast using wet casting processes.

The form assembly 12 may have a stacking structure, such as a stacking post, to minimize floor space during the curing process. One or more stacking posts may be used for lifting the form assembly 12.

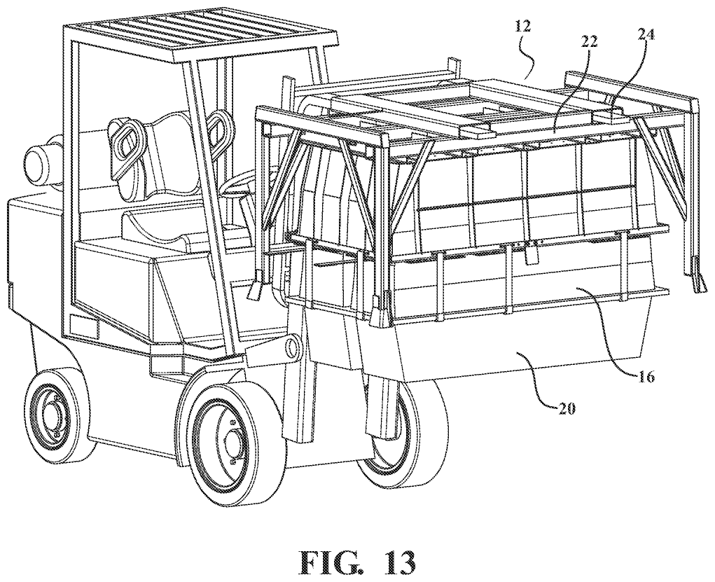

As best seen in FIGS. 1, 4, 9, and 13, and as a non-limiting example, the form assembly 12 includes a rigid support member (e.g., a tub) 22 surrounding the remaining components of the form assembly 12 therein. The tub 22 may be made from a rigid material, such as steel. The tub 22 may include any number of support rails, tubes, channels, etc. in any suitable configuration with the necessary strength. The form assembly 12 comprises a plurality of slots 24 adapted for receiving forklift tines to allow lifting, moving, rotating, separating, and inverting of the tub 22 together with the form assembly 12, the mold assembly 16, and any blocks cast in the cavities 18. The tub 22 may also be lifted, moved, and inverted with other automated transfer machines. One of ordinary skill in the art would understand that the tub 22 may have other shapes and configurations in other embodiments

As best seen in FIGS. 4, 9, and 10, the cavities 18 of the mold assembly 16 have configurations designed for receiving and retaining one or more insert assemblies 26, such as mold inserts. In this embodiment, each of the insert assemblies 26 comprises two cavity inserts 28 that are each substantially wedge-shaped and an insert mounting structure 30 connected to upper surfaces of both of the cavity inserts 28. The insert mounting structure 30 is substantially perpendicular to each of the cavity inserts 28 of the insert assembly 26. The cavity inserts 28 may be made from a variety of suitable materials, such as polyurethane. One of ordinary skill in the art would understand that the cavity inserts 28 may comprise various shapes, configurations, and materials in other embodiments.

As best seen in FIGS. 1, 4, and 8, and as a non-limiting example, two insert assemblies 26 are positioned within the two cavities 18 on opposing ends of the mold assembly 16 in the first configuration of the forming system 10. As a result, the middle portion 42 is interposed between and in contact with the cavity inserts 28 on the two insert assemblies 26. This design helps prevent the mold assembly 16 from being inverted or misshaped during the demolding and re-insertion process when the mold assembly 16 includes a plurality of cavities 18. One of ordinary skill in the art would understand that in other embodiments the forming system 10 may include either one insert or more than two inserts, and that the inserts may be positioned in other positions on the mold assembly 16.

In the first configuration shown in FIGS. 1-3, each of the cavity inserts 28 of each insert assembly 26 is inserted into the cavities 18, while the insert mounting structure 30 of each insert assembly 26 is positioned above the surface of the cavities 18 on the mold assembly 16. In a non-limiting example, the insert mounting structure 30 on each of the insert assemblies 26 is substantially rectangularly-shaped and includes a hole 32 therein. The hole 32 in the insert mounting structure 30 is adapted to selectively receive and retain one or more portions of the frame 34. One of ordinary skill in the art would understand that the insert mounting structure 30 of the insert assemblies 26 may also have other configurations in other embodiments.

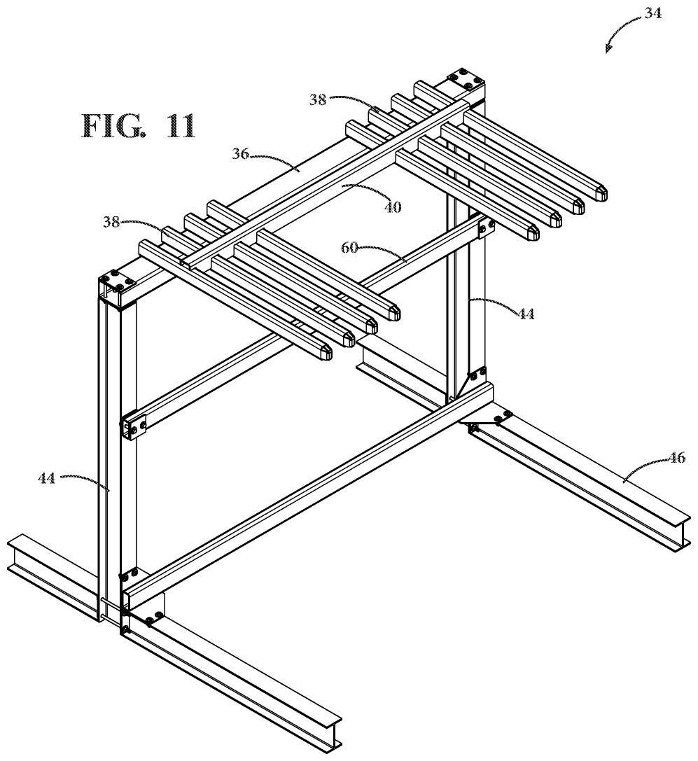

As best seen in FIGS. 1, 4, 8, and 11, and as a non-limiting example, the frame 34 is a reaction frame comprising a support structure 36, a plurality of arms 38 extending perpendicularly from the support structure 36, and one or more cross tubes 40, 60 extending in a direction that is substantially parallel to the support structure 36. The frame 34 is operably configured to provide a resistance force on the insert assemblies 26. The cross tubes 40, 60 are operably configured to help an operator of a machine, such as a forklift operator, better align the form assembly 12 with portions of the frame 34 and to reinsert the insert assemblies 26.

In an embodiment, one or more portions of the arms 38 are tapered in order to reduce misalignment of the insert assemblies 26 into the arms 38. This makes it easier for an operator to remove and re-insert the insert assemblies 26 during operation.

In an embodiment, the frame 34 may also comprise a pair of vertical structures 44 connected to ends of the support structure 36 and a pair of frame feet 46 connected to and perpendicular to the vertical structures 44. For example, the vertical structures 44 may be I-beams. The vertical structures 44 are connected to each other by the cross tube 60. The frame feet 46 are positioned on the ground. The frame 34 may comprise a variety of different components and configurations in other embodiments. For example, one or more components of the frame 34 may be positioned directly on the ground or on another object, such as a wall, depending on intended uses of other forming systems. As a result, the height of one or more components of the frame 34 may be adjusted.

In an embodiment, the frame 34 comprises two sets of four arms 38 (i.e. eight arms 38 total), wherein the sets of four arms 38 are spaced apart from each other along the support structure 36. The space between the sets of four arms 38 is greater than the combined spaces between each of the individual arms 38 in the individual sets. The arms 38 provide contact stops for portions of the form assembly 12. The result is improved spacing and alignment of the form assembly 12 with respect to the frame 34 during demolding of concrete blocks and re-insertion of the molds. Additionally, no people are needed to manually adjust the placement of the insert assemblies 26 when a forklift operator aligns the form assembly 12 in order to fully demold concrete blocks and to re-insert mold. One of ordinary skill in the art would understand that the frame 34 may comprise either fewer than or more than eight arms 38 and that the orientation and positioning of the arms 38 on the support structure 36 may vary in other embodiments.

In the first configuration of the forming system 10, two of the arms 38 are inserted through the holes 32 on the insert mounting structure 30 of the insert assemblies 26. In an embodiment, the arms 38 that are inserted through the insert mounting structure 30 are the second furthest away from the middle of the support structure 36 in order to further improve the alignment of the form assembly 12 with the frame 34. Other arms 38 may be inserted through the insert mounting structure 30 of the insert assemblies 26 in other embodiments.

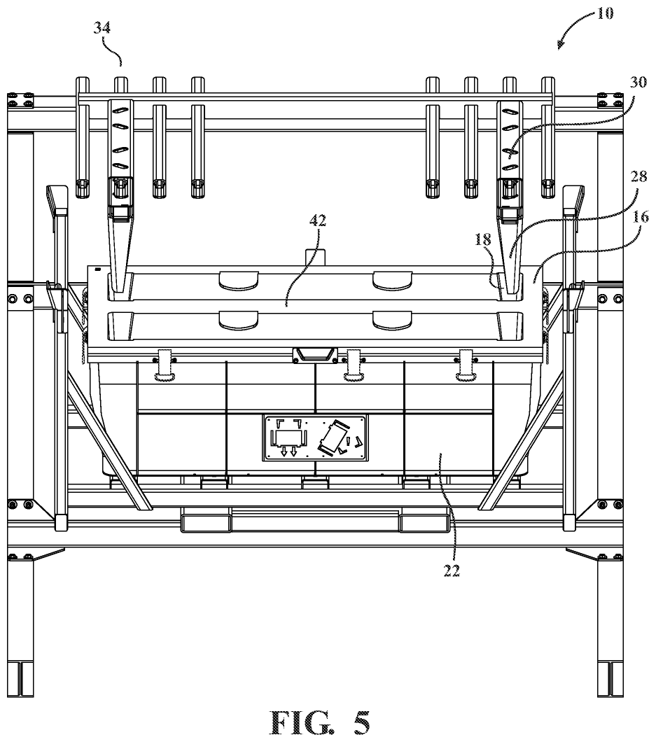

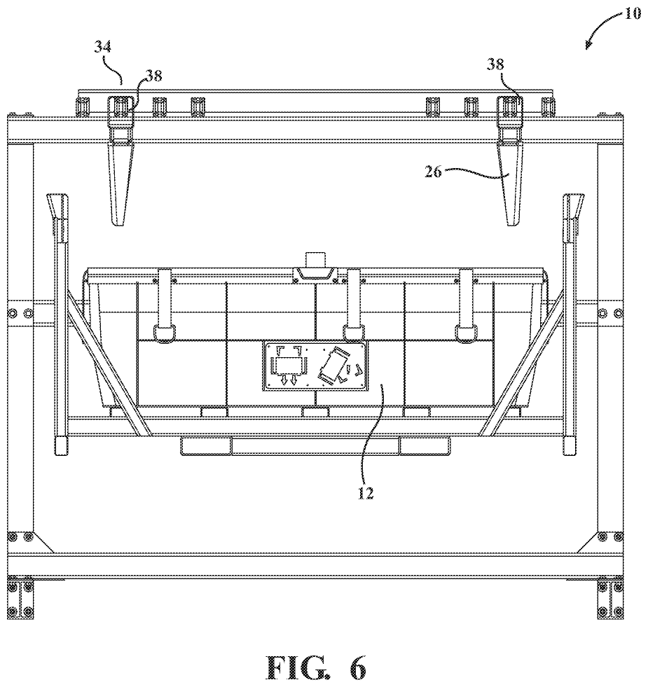

FIGS. 4-6 and 10 illustrate views of the forming system 10 in a second configuration according to an embodiment of the disclosure. In this configuration, the insert assemblies 26 are removed from the mold assembly 16 and are positioned/retained on the arms 38 of the frame 34.

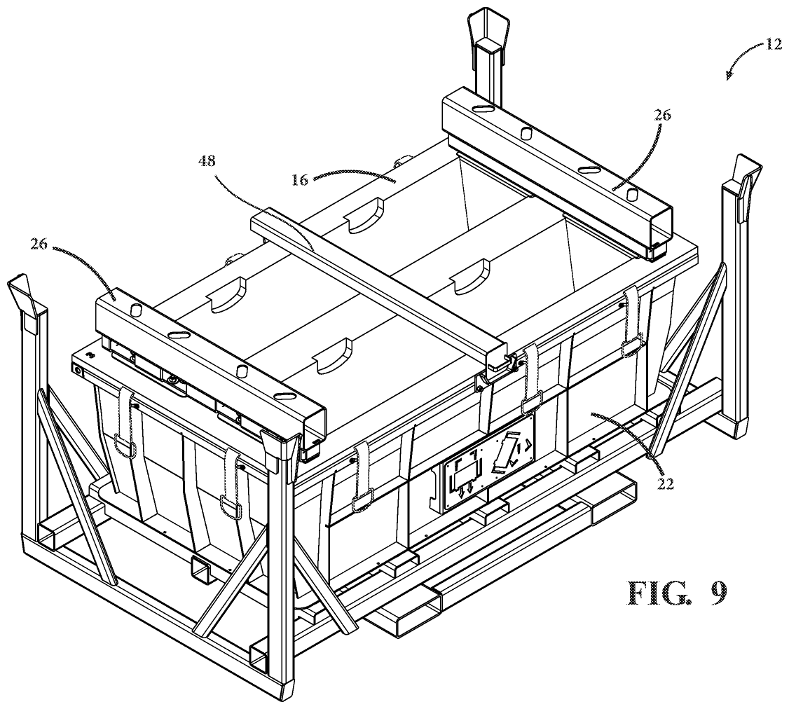

In the embodiment shown in FIG. 9 the form assembly 12 includes a hook holder 48 positioned between the insert assemblies 26 and in about the center of the mold assembly 16. The hook holder 48 may be positioned through the middle of lift hooks (not shown) located on the concrete blocks 20. Once the concrete blocks 20 are partially cured to allow handling, the hook holder 48 may be removed so that the lift hooks may be used to readily remove the concrete blocks 20.

In the embodiment disclosed herein, the form assembly 12 and the mold assembly 16 each have a length of about 6 feet. In other embodiments, form assemblies and the mold inserts that are inserted therein may each have shorter lengths, such as about 4 feet or 5 feet, or they may each have longer lengths, such as 7 feet or more.

In an alternative embodiment, a form assembly does not include a mold assembly or mold liner. As a result, blocks are cast directly in the form assembly and portions of the inner surfaces of one or more sides of the form assembly are tapered (i.e. drafted at an angle). This helps blocks to be separated from form assemblies during the demolding process.

In an alternative embodiment, a form assembly does not engage with a reaction frame. Instead, inserts may be demolded from and reinserted into the form assembly by an operator or other automated transfer machine.

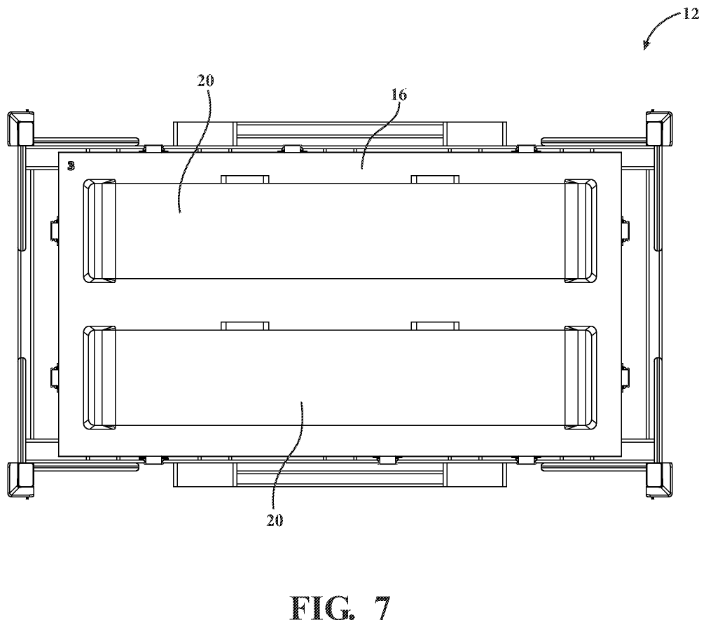

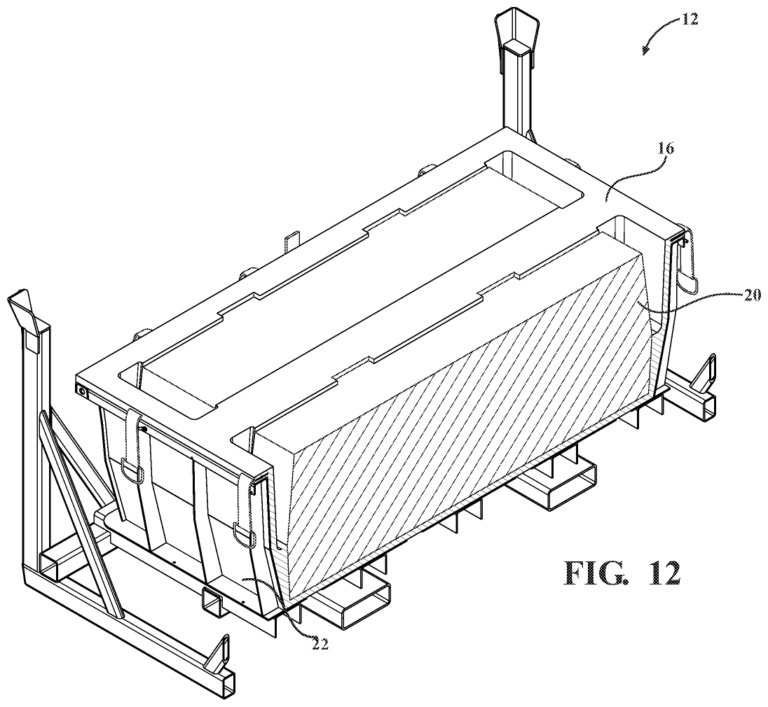

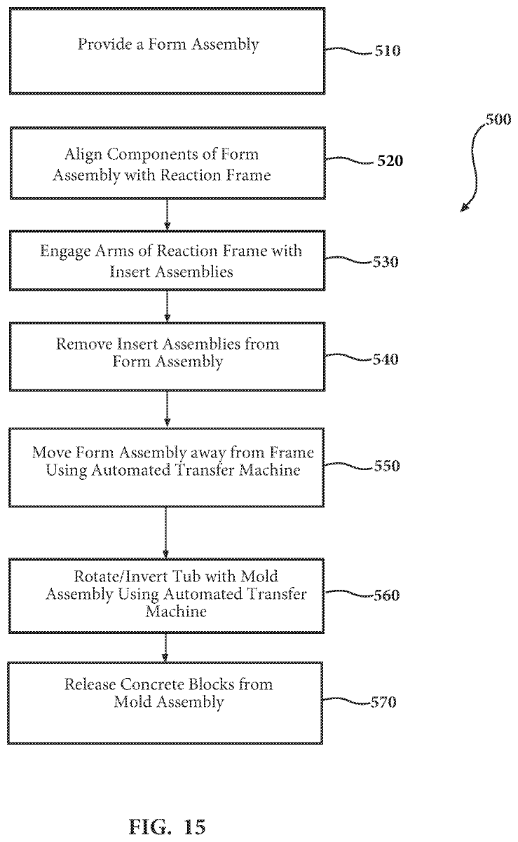

FIG. 15 illustrates a flow chart of an exemplary method 500 for demolding one or more cast concrete blocks. The method 500 commences at block 510 by providing the form assembly 12 illustrated in FIGS. 1-10, 12, and 13. Next, as shown in block 520, one or more components of the form assembly 12 are aligned/centered with the reaction frame 34, namely the arms 38 of the frame 34. For example, the rigid support member/tub 22 may be aligned with the frame 34 using a forklift or other automated transfer machine. For example, tines of a forklift may be inserted into the slots 24 of the form assembly 12.

Next, as shown in block 530, one or more arms 38 of the frame 34 are engaged with portions of one or more of the insert assemblies 26. For example, one or more arms 38 may be inserted through the insert mounting structures 30 of one or more of the insert assemblies 26 during alignment of the form assembly 12. Specifically, the arms 38 may be inserted through the hole 32 found on the insert mounting structures 30 of each insert assembly 26. This provides reaction and a contact stop for the insert assemblies 26.

Next, as shown in block 540, the insert assemblies 26 are removed from the form assembly 12. For example, the form assembly 12 is pulled vertically down away from the frame 34, while the inserts 26 stay put on the arms 38 of the frame 34. The arms 38 of the frame 34 remain inserted through the insert mounting structures 30 of the insert assemblies 26. The form assembly 12 including the tub 22 may remain on the forklift tines during this process. Tines on the forklift may be moved to change the spacing between the tines. The mold assembly 16 remains mated to the interior surfaces of the form assembly 12 during block 540. In other embodiments, a form may be either pulled upwards or sideways from a frame depending on the orientation of the frame or its arms.

Next, as shown in block 550, an automated transfer machine (e.g. forklift with rotator attachment) moves the tub 22 with the mold assembly 16 away from the frame 34. The tub 22 with the mold assembly 16 is also rotated/inverted above a surface that will be able to catch the concrete blocks 20, as shown in block 560. For example, the form assembly 12 may be moved and/or rotated 180° to invert the tub 22 and the mold assembly 16.

The concrete blocks 20 will then be released from the mold assembly 16, as shown in block 570. The mold assembly 16 moves/translates out of the tub 22, while the concrete blocks 20 remain mated to the mold assembly 16. In this embodiment, the mold assembly 16 is then stretched from its corners and edges and will deform sufficiently to allow the cured concrete blocks 20 to separate and be fully removed from the cavities 18 of the mold assembly 16 onto the tines of the forklift. The concrete blocks 20 may be removed from the mold assembly 16 by the weight exerted by the concrete blocks 20 and/or by the supplemental force supplied by the forklift attachment/automated transfer machine.

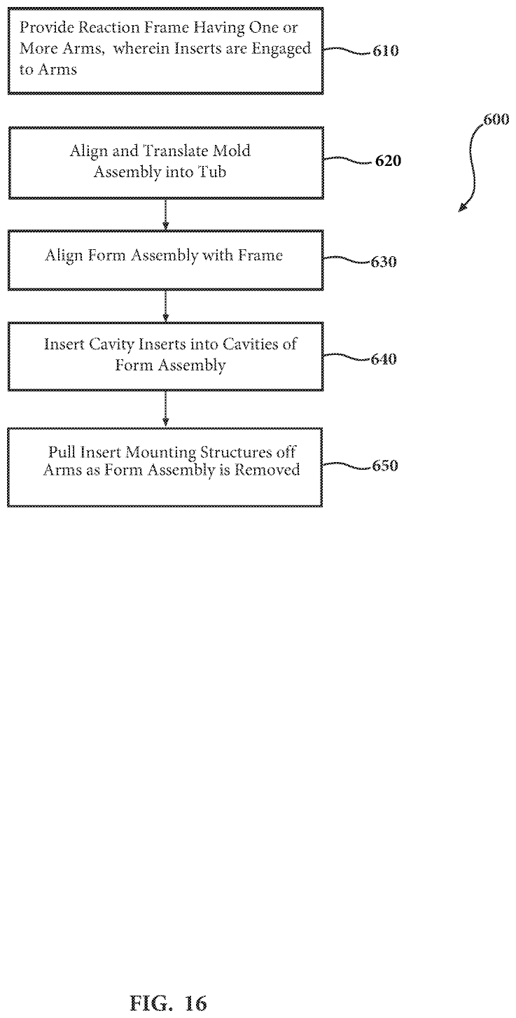

FIG. 16 illustrates a flow chart of an exemplary method 600 for inserting/reinserting one or more of the insert assemblies 26 into the mold assembly 16 illustrated in FIGS. 1-10, 12, and 13. The method 600 commences at block 610 with providing the frame 34 illustrated herein, wherein one or more of the insert assemblies 26 are engaged to the one or more extending arms 38.

Next, as shown in block 620, the mold assembly 16 aligns and translates back into the tub 22. For example, the translation may occur by self-aligning one or more surfaces on the mold assembly 16 within the interior of the tub 22 in order to reconfigure the mold assembly 16 back to a position where concrete may be poured into the cavities 18. In an embodiment, the side surfaces on the mold assembly 16 are tapered. Tapered angles of the mold assembly 16 may vary depending on the desired block or wall product.

Next, as shown in block 630, the form assembly 12 is aligned with the frame 34. For example, the alignment may be done based on the perspective of a forklift operator. The arms 38 provide left-right & up-down orientation that serves as a “visual” guide for the operator. The cross tubes 40, 60 provide front-back orientation that serves as “contact feedback” guidance for the operator. For example, the operator may contact the cross tubes 40, 60 with the form assembly 12 and then move the form assembly 12 slightly forward.

In an embodiment, the form assembly 12 may be picked up and moved by inserting the forklift tines into the slots 24 on the form assembly 12. The form assembly 12 is aligned such that the insert assemblies 26 on the frame 34 are positioned over the cavities 18.

Next, as shown in block 640, the cavity inserts 28 of the insert assemblies 26 are re-inserted into the cavities 18 of the form assembly 12. The form assembly 12 is then moved away from the frame 34 using the forklift or other automated transfer machine. The insert mounting structures 30 are then pulled off of the arms 38 as the form assembly 12 is removed, as shown in block 650.

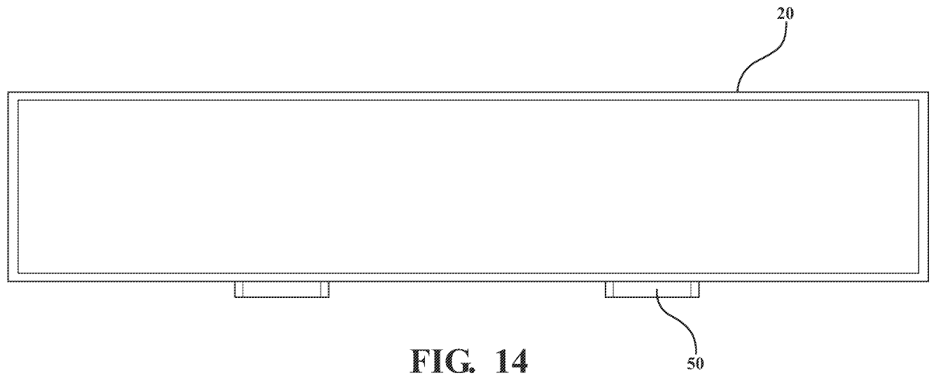

As best seen in FIG. 14, and as a non-limiting example, the concrete blocks 20 may include a setback heal 50, such as a knob, a groove, or the like. The setback heal 50 aids in the proper installation of the concrete blocks 20 on a wall.

The present disclosure provides improved forming systems and methods for producing reverse tapered blocks, which allow for quicker, easier, and more efficient removal and re-installation of inserts. Some of the significant benefits involve ease of alignment of the inserts into the form assembly; a reduction in manual labor and costs; and an increase in efficiency. There is no longer a need for a human operator to do any of the following manually/by hand: remove inserts/re-insert inserts into the form assembly; clean the form assembly; or align the inserts in the form assembly.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to form the inventive concepts defined in the appended claims.

In accordance with the provisions of the patent statutes, the present disclosure has been described to represent what is considered to represent the preferred embodiments. However, it should be noted that this disclosure can be practiced in other ways than those specifically illustrated and described without departing from the spirit or scope of this disclosure.

What is claimed is:

1. A forming system comprising:
a form assembly configured to cast a concrete block, wherein the form assembly comprises:
a plurality of sides defining one or more openings;
a mold liner selectively inserted within the one or more openings, wherein the mold liner includes a plurality of sides and one or more cavities;
a rigid support member surrounding the mold liner; and
one or more insert assemblies configured to selectively insert into the one or more cavities in the mold liner; and
a reaction frame, wherein the reaction frame comprises one or more extending arms configured to selectively engage with the one or more insert assemblies.

2. The forming system of claim 1, wherein one or more of the sides of the mold liner are tapered.

3. The forming system of claim 1, wherein the form assembly includes one or more straps on the mold liner, wherein the one or more straps are configured to moveably connect the mold liner to the rigid support member.

4. The forming system of claim 1, wherein the rigid support member includes one or more slots.

5. The forming system of claim 1, wherein each of the insert assemblies comprises:
one or more first portions that are each selectively inserted within the cavities of the mold liner; and
a second portion attached to the first portion, wherein the second portion includes a hole adapted for receiving at least one of the extending arms of the reaction frame.

6. The forming system of claim 1, wherein the reaction frame further comprises a support structure that extends perpendicularly across at least a portion of each of the extending arms.

7. The forming system of claim 1, wherein the mold liner includes two insert assemblies positioned on opposite ends thereof and a hook holder positioned between the two insert assemblies.

8. The forming system of claim 1, further comprising a plurality of concrete blocks positioned within the mold liner.

9. The forming system of claim 5, wherein the second portion of each of the insert assemblies is substantially perpendicular to each of the one or more first portions of each of the insert assemblies.

10. A method for demolding one or more concrete blocks from a form assembly, the method comprising:
providing a form assembly comprising:
a mold liner inserted within one or more openings in the form assembly,
wherein the mold liner includes one or more cavities;
a rigid support member surrounding the mold liner;
one or more concrete blocks in the cavities of the mold liner; and
one or more inserts positioned within the mold liner;
aligning the form assembly with respect to a reaction frame;
engaging one or more portions of the reaction frame with portions of one or more of the inserts;
removing the one or more inserts from the mold liner by pulling the form assembly away from one or more portions of the reaction frame;
moving the rigid support member with the mold liner and one or more concrete blocks therein away from the reaction frame;
rotating the rigid support member with the mold liner and one or more concrete blocks; and
releasing the one or more concrete blocks from the mold liner.

11. The method of claim 10, wherein one or more arms on the reaction frame are engaged with one or more portions of the inserts.

12. The method of claim 10, wherein the one or more arms on the reaction frame are inserted within a hole on one or more of the inserts.

13. The method of claim 10, wherein the mold liner remains inserted within the form assembly when the one or more inserts are removed from the mold liner.

14. The method of claim 10, wherein the mold liner translates out of the form assembly prior to releasing the one or more concrete blocks from the mold liner.

15. A method for inserting one or more inserts into a form assembly, the method comprising:
providing a reaction frame having one or more extending arms, wherein one or more inserts are engaged to the one or more extending arms;
translating a mold liner into a rigid support member on a form assembly, wherein the mold liner includes one or more cavities;
aligning the form assembly with the reaction frame such that the one or more inserts are positioned over the cavities in the mold liner;
inserting one or more of the inserts into the cavities; and
removing the form assembly from the reaction frame such that the inserts are no longer engaged with the reaction frame.

16. The method of claim 15, wherein translating the mold liner involves self-aligning one or more surfaces on the mold liner within the interior of the rigid support member.

17. A form assembly configured to cast a concrete block, the form assembly comprising:
a plurality of sides defining one or more openings;
a mold liner selectively inserted within the one or more openings, wherein the mold liner includes one or more tapered sides and one or more cavities;
a rigid support member surrounding the mold liner; and
one or more inserts positioned in the one or more cavities of the mold liner.

18. The form assembly of claim 17, further comprising one or more straps on the mold liner, wherein the one or more straps are configured to moveably connect the mold liner to the rigid support member.

19. The form assembly of claim 17, wherein the rigid support member includes one or more slots.
